(19) United States
(12) Patent Application Publication
(10) Pub. No.: US 2004/0047408 A1
(43) Pub. Date: Mar. 11, 2004

(54) Data link analyzer

(76) Inventors: Ingo Koenenkamp, Braunschweig (DE); Andreas Schulten, Braunschweig (DE)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/238,669

(22) Filed: Sep. 10, 2002

(51) Int. Cl. H04B 3/46; H04B 17/00; H04Q 1/20

(52) U.S. Cl. 375/224

(57) ABSTRACT

A system and method of evaluating transmission errors in data received at a sink device are described. The sink device may receive a test data sequence on each of a plurality of data lanes and detect transmission errors associated with specific data lanes. The sink device may then output data representative of at least some of the detected transmission errors in association with at least one of a data interval and a data lane.

### BACKGROUND

1. Field

The subject matter disclosed herein relates to data communication. In particular, the subject matter disclosed herein relates to data communication in a data link.

2. Information

Data transmission standards directed to high speed communication over optical transmission media such as 10 and 40 Gigabit Ethernet, or Synchronous Optical Network/Synchronous Digital Hierarchy (SONET/SDH) have brought about a need for high speed communication between components or modules in systems employing such standards. For example, IEEE Std. 802.3ae-2002 defines a 10 Gigabit Attachment Unit Interface (XAUI) to transmit data between 10 Gigabit Media Independent Interfaces (XGMIIs) through a data link. Also, the Optical Internetworking Forum (OIF) defines System Packet Interfaces (SPIs) at Levels SPI-1 through SPI-5 for different data rates.

Increased data rates from the use of higher speed transmission media has increased data rates on chip to chip interconnections between and among functional communication devices. The higher data rates typically increase the incidence of transmission errors when transmitting data between devices on a chip to chip interconnection.

### BRIEF DESCRIPTION OF THE FIGURES

Non-limiting and non-exhaustive embodiments of the present invention will be described with reference to the following figures, wherein like reference numerals refer to like parts throughout the various figures unless otherwise specified.

FIG. 1 shows a diagram of a system comprising a source device and a sink device coupled by data lanes formed in a printed circuit board.

FIG. 2 shows a diagram illustrating an association of transmission errors with data lanes and data intervals according to an embodiment of the system shown in FIG. 1.

FIGS. 3 through 6 illustrate an association of transmission errors with data lanes and data intervals according to alternative embodiments of the system shown in FIG. 1.

FIG. 7 illustrates signal power of data signals in substantially aligned data lanes sampled during synchronized bit sample intervals.

FIG. 8 illustrates signal power of data signals in substantially misaligned or skewed data lanes sampled during synchronized bit sample intervals.

### DETAILED DESCRIPTION

Reference throughout this specification to “one embodiment” or “an embodiment” means that a particular feature, structure, or characteristic described in connection with the embodiment is included in at least one embodiment of the present invention. Thus, the appearances of the phrase “in one embodiment” or “an embodiment” in various places throughout this specification are not necessarily all referring to the same embodiment. Furthermore, the particular features, structures, or characteristics may be combined in one or more embodiments.

“Machine-readable” instructions as referred to herein relates to expressions which may be understood by one or more machines for performing one or more logical operations. For example, machine-readable instructions may comprise instructions which are interpretable by a processor compiler for executing one or more operations on one or more data objects. However, this is merely an example of machine-readable instructions and embodiments of the present invention are not limited in this respect.

“Storage medium” as referred to herein relates to media capable of maintaining expressions which are perceivable by one or more machines. For example, a machine readable medium may comprise one or more storage devices for storing machine-readable instructions or data. Such storage devices may comprise storage media such as, for example, optical, magnetic or semiconductor storage media. However, this is merely an example of a machine-readable medium and embodiments of the present invention are not limited in this respect.

“Logic” as referred to herein relates to structure for performing one or more logical operations. For example, logic may comprise circuitry which provides one or more output signals based upon one or more input signals. Such circuitry may comprise a finite state machine which receives a digital input and provides a digital output, or circuitry which provides one or more analog output signals in response to one or more analog input signals. Such circuitry may be provided in an application specific integrated circuit (ASIC) or field programmable gate array (FPGA). Also, logic may comprise machine-readable instructions stored in a storage medium in combination with processing circuitry to execute such machine-readable instructions. However, these are merely examples of structures which may provide logic and embodiments of the present invention are not limited in these respects.

A “processing system” as discussed herein relates to a combination of hardware and software resources for accomplishing computational tasks. However, embodiments of the present invention are not limited in this respect. A “host processing system” relates to a processing system which may be adapted to communicate with a “peripheral device.” For example, a peripheral device may provide inputs to or receive outputs from an application process hosted on the host processing system. However, embodiments of the present invention are not limited in this respect.

A “data bus” as referred to herein relates to circuitry for transmitting data between devices. For example, a data bus may transmit data between a host processing system and a peripheral device. However, this is merely an example and embodiments of the present invention are not limited in this respect.

A “data link” as referred to herein relates to circuitry to transmit data between devices. A data link may provide point to point communication between two devices in either unidirectionally or bi-directionally. However, this is merely an example of a data link and embodiments of the present invention are not limited in this respect.

A data link may comprise a plurality of “data lanes” where each data lane transmits data from a source to a destination independently of other data lanes. Each data lane in a data link may transmit a data signal in a transmission medium which is converted to data bits at a destination. The data bits from the data lanes may then be combined. Data lanes may be used to couple a “source device” to a “sink device” to enable the source device to transmit data to the sink device. However, these are merely examples of data lanes that may be used to transmit data in a data link and embodiments of the present invention are not limited in these respects.

A “transmission error” as referred to herein relates to a condition in which one or more data bits extracted from a data signal at a destination are inaccurate. For example, a transmission error may be caused by a low signal to noise condition at the destination that does not permit an accurate detection of one or more data bits from the data signal. A transmission error may also be caused by temporal misalignment of the data signal with respect to circuitry at a destination to extract the data bits. However, these are merely examples of transmission errors and embodiments of the present invention are not limited in these respects.

A “test data sequence” as referred to herein relates to data transmitted in data lanes or a data link to detect transmission errors. For example, a data signal in a data lane may transmit a test data sequence from a source device to a sink device to detect transmission errors at the sink device. Such a test data sequence may comprise a predetermined sequence of data bits such as a pseudo random bit sequence. However, these are merely examples of a test data sequence and embodiments of the present invention are not limited in these respects.

A “data interval” as referred to herein relates to an interval during which a device may receive data bits from a data lane. For example, a data interval may comprise a bit sample interval during which a data signal is sampled to recover one or more data bits from the data signal. Alternatively, a data interval may comprise a plurality of bit sample intervals during which a data signal is sampled to recover one or more data bits at each bit sample interval. However, these are merely examples of a data interval and embodiments of the present invention are not limited in these respects.

Briefly, an embodiment of the present invention relates to a system and method of evaluating transmission errors in data received at a sink device. The sink device may receive a test data sequence on each of a plurality of data lanes and detect transmission errors associated with specific data lanes. The sink device may then output data representative of at least some of the detected transmission errors in association with at least one of a data interval and a data lane. However, this is merely an example embodiment and other embodiments of the present invention are not limited in these respects.

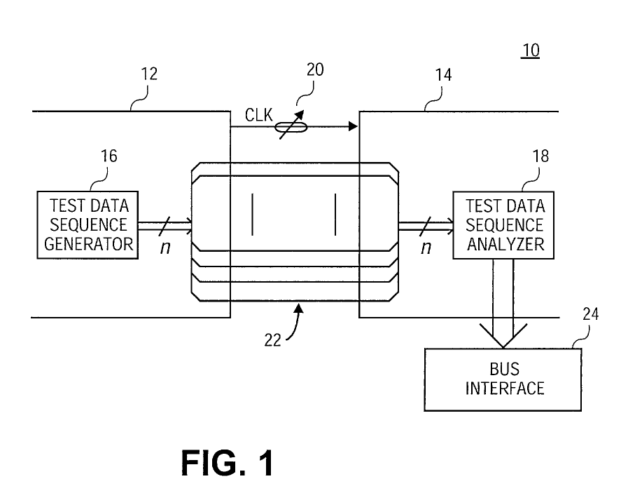

FIG. 1 shows a diagram of a system 10 comprising a source device 12 and a sink device 14 coupled by a plurality of data lanes 20. In one embodiment, the data lanes 20 may be formed in circuit traces (e.g., copper) of a printed circuit board (PCB). Accordingly, the source device 12 and sink device 14 may be coupled to the circuit traces by any one of several connections such as a ball grid array socket or solder bonding. The source device 12 may transmit a data signal to the sink device 14 in each of the data lanes 20 to transmit data bits. The data signal may be a single ended signal or may be transmitted as a differential pair signal. However, these are merely examples of how data signal may be transmitted in a data lane and embodiments of the present invention are not limited in these respects.

According to an embodiment, the source device 12 may receive serial or parallel data from another source (not shown) and format the data for transmission to the sink device 14 through the data lanes 22. The system 10 comprises n data lanes 22 where n may be any integer number such as, for example, sixteen. Upon receipt of data from each of the data lanes 22, the sink device may format the extracted data bits for transmission in one of several different formats such as, for example, a serial or parallel format for transmission to another device (not shown).

In one embodiment, the source device 12 and the sink device 14 may comprise any one of several devices capable of transmitting or receiving data though data lanes formed in a chip to chip interconnection. For example, in an embodiment in which the source device 12 and sink device 14 are included in a port for a Synchronous Optical Network/Synchronous Digital Hierarchy (SONET/SDH) based network or Optical Transport Network (OTN), the source device 12 and sink device 14 device pair may comprise a forward error correction (FEC) device coupled to a framer device, a framer device coupled to a packet processor (e.g., packet classifier or network processor), or a framer coupled to a physical layer device (e.g., including a seializer/deserializer (SERDES)). However, these are merely examples of source or sink devices at a SONET/SDH port that may transmit data in data lanes formed in a chip to chip interconnection and embodiments of the present invention are not limited in these respects.

Alternatively, in an embodiment in which the source device 12 and sink device 14 are included in a port for an Ethernet network, the source device 12 and sink device 14 device pair may comprise a media access control (MAC) device coupled to a physical layer device (e.g., including a SERDES), two extender sublayer devices (e.g., two 10 Gigabit Extender Sublayer (XGXS) devices) forming an extended attachment unit interface (e.g., a 10 Gigabit Attachment Unit Interface (XAUI)), a MAC device coupled to a packet processor, a MAC device coupled to an extender sublayer device, or a physical layer device coupled to an extender sublayer device. However, these are merely examples of source or sink devices at an Ethernet port that may transmit data in data lanes formed in a chip to chip interconnection and embodiments of the present invention are not limited in these respects.

While in one embodiment the data lanes 22 may be formed in traces of a PCB, in another embodiment the data lanes 22 may couple the source device 12 and sink device 14 by an optical transmission medium. For example, the source device 12 may be coupled to an optical transmitter to transmit data in an optical signal through fiber optic cabling while the sink device is coupled to an optical receiver to recover the data from the received optical signal. The optical transmitter may transmit, and the optical receiver may receive, multiple data lanes in the optical transmission medium using techniques known to those of ordinary skill in the art such as, for example, wave division multiplexing. However, this is merely an example of how data lanes in an optical transmission medium may couple a source device to a sink device, and embodiments of the present invention are not limited in this respect.

According to an embodiment, the sink device 14 comprises circuitry to sample data signals on each of the data lanes 22 to recover or extract the transmitted data bits on periodic sample intervals. In addition to transmitting data bits in data lanes 22, the source device 12 may also provide a periodic clock signal 20 to the sink device 14 which is synchronized with bit intervals in the data signal. Accordingly, the sink device 14 may sample each of the data lanes at the periodic sample intervals in response to the clock signal 20.

According to an embodiment, the source device 12 may comprise a test data sequence generator 16 to generate a test data sequence on each of the data lanes 22 as part of a test procedure. The test data sequence may comprise a predetermined sequence of data bits such as, for example, a pseudo random bit sequence which may be generated using techniques known to those of ordinary skill in the art. However, this is merely an example of a test data sequence and embodiments of the present invention are not limited in these respects. Correspondingly, the sink device 14 may comprise a test data sequence analyzer 18 to detect data transmission errors on any data lane and on any bit sample interval. For each data lane 22, the test data sequence data analyzer 18 may compare the data bits recovered from the data signal on the data lane 22 with a known test data sequence and detect errors at specific bit intervals when the recovered data does not match a corresponding bit in the test data sequence.

The test data sequence analyzer 18 may associate detected errors with corresponding data lanes 22 and bit sample intervals in a data file to be output to a data bus (not shown) coupled to a data bus interface 24. The data file may then be analyzed by application programs hosted on a host processing system (not shown) coupled to the bus interface 24 through the data bus (not shown). The data bus may comprise any one of several data bus architectures for transmitting data from a peripheral device to a host processing system such as, for example, a data bus architecture compliant with the Peripheral Components Interconnection (PCI) Local Bus Specification, Rev. 2.3, Mar. 29, 2002. However, this is merely an example of a data bus architecture and embodiments of the present invention are not limited in this respect.

The application programs may be executed from machine-readable instructions stored in a storage medium at the host processing system. Such application programs may analyze the data file to quantify bit error rates (BERs) associated with the individual data lanes 22 or the entire data link formed by the combination of the data links 22. Also, as discussed below, such applications may analyze data from evaluation intervals with bit sample intervals at staggered phases relative to the data signals to infer as to whether the data signals on different data lanes 22 are misaligned or skewed when received at the sink device 14.

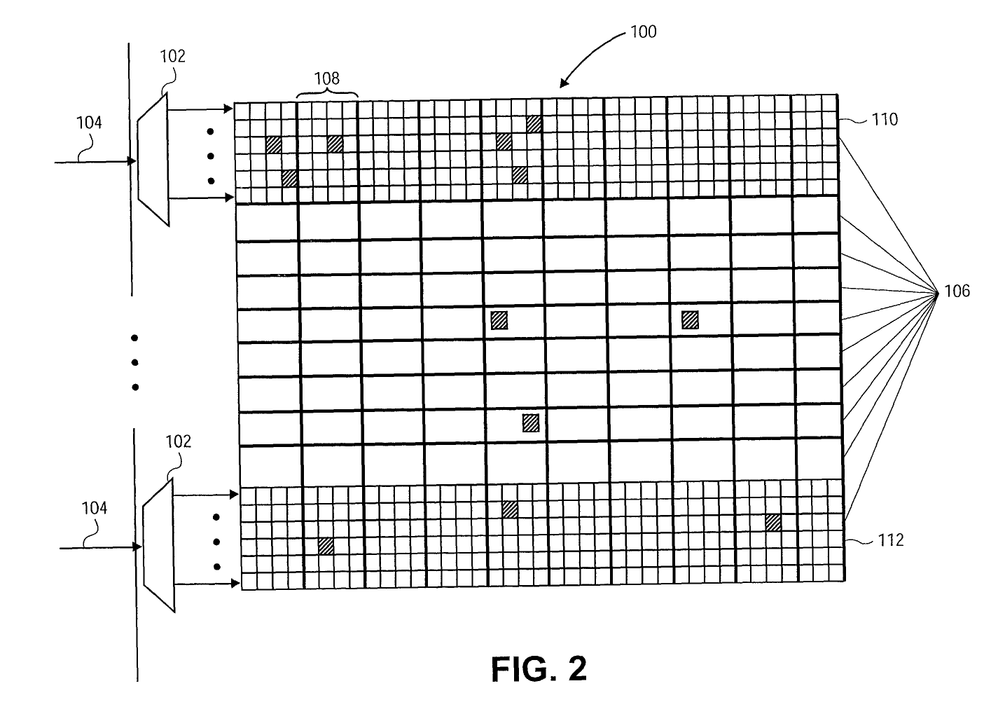

FIG. 2 shows a diagram illustrating a mapping 100 of transmission errors with data lanes and data intervals according to an embodiment of the system shown in FIG. 1. At a sink device, each of a plurality of data signals 104 (each data signal 104 corresponding with a data lane) may be received at a corresponding demultiplexer 102. At each bit sample interval, the data signal 104 may be sampled at a corresponding demultiplexer 102 to provide one or more bits at the bit sample interval. In the illustrated embodiment, the corresponding demultiplexer 102 is shown providing six data bits upon each sample of the data signals 104 but it should be understood that in other embodiments a demultipexer may provide any number of data bits such as one, four, sixteen or more data bits upon each sample. Again, these are merely examples of the number of data bits that a demultiplexer may sample from a data signal on a bit sample interval and embodiments of the present invention are not limited in these respects.

In the illustrated embodiment, the mapping 100 may indicate the accuracy of bits sampled at bit sample intervals where a clear box represents an accurately sampled bit and a darkened box represents a transmission error at a location corresponding with an associated data lane (e.g., based upon a comparison of a bit detected from the data signal and a corresponding bit in the test data sequence). An evaluation interval may comprise a plurality of data block intervals 108. In the illustrated embodiment, a data block interval 108 covers four bit sample intervals but it should be understood that a data interval may cover one or more than four bit sample intervals.

According to an embodiment, the test data sequence analyzer 18 may generate files that compress or summarize errors detected at each data lane and each bit sample interval over an evaluation period. In the presently illustrated embodiment, for example, an evaluation period comprises ten data block intervals 108. These files may then be transmitted to the host processing system via the bus interface 24. While the data sequence analyzer 18 may not report every bit sample error detected on each data lane for each bit sample interval, the data sequence analyzer may provide to the host processing system compressed data for each evaluation period summarizing the errors detected over the evaluation period.

According to an embodiment, the data sequence analyzer 18 may maintain counters to track the detection of errors. For each data lane, for example, one counter may count the number of single bit errors detected in the data lane during the evaluation period and another counter may count the number of data blocks 108 in the evaluation period having one or more errors in the data lane. Also, another counter may count the number of data block intervals 108 or bit sample intervals in the evaluation period for which there is at least one bit sample error (for each data lane individually for all data lanes). Another counter may count the total number of bit sample errors over the evaluation period. It should be understood, however, that these are merely examples of counters that may be maintained to compress bit sample error data and embodiments of the present invention are not limited in these respects. These counters may be updated at each bit sample interval. At the end of an evaluation period, the data sequence analyzer 18 may output compressed data including the counts to the host processing system through the bus interface 24 and the counters may be cleared.

In one example, based upon a count of the number of single bit errors detected for each data lane over the evaluation period and a count of the number of data block intervals 108 having one or more single bit errors may be counted, an application program may deduce how single bit errors are temporally distributed in a data lane over the evaluation period. In the example illustrated in FIG. 2, for example, six single bit errors may be counted for the upper most data lane 110 while three single bit errors may be counted for the lower most data lane 112. Also, three data block intervals 108 in the upper most data lane 110 and the lower most data lane 112 have one or more single bit errors. From this data, an application program may infer that the single bit errors in the upper most data lane 110 are concentrated in specific data block intervals 108 (i.e., all six single bit errors detected in only three data block intervals 108) while the single bit errors in the lower most data lane 112 are not as concentrated (i.e., no more than one single bit error in any single data block interval 108).

In another example, based upon a count of the number of single bit errors detected at each bit sample interval totaled over all data lanes 106, and a count of bit sample intervals or data block intervals 108 having one or more single bit errors in any data lane 106 an application program may infer a concentration or distribution of the single bit errors over the evaluation period.

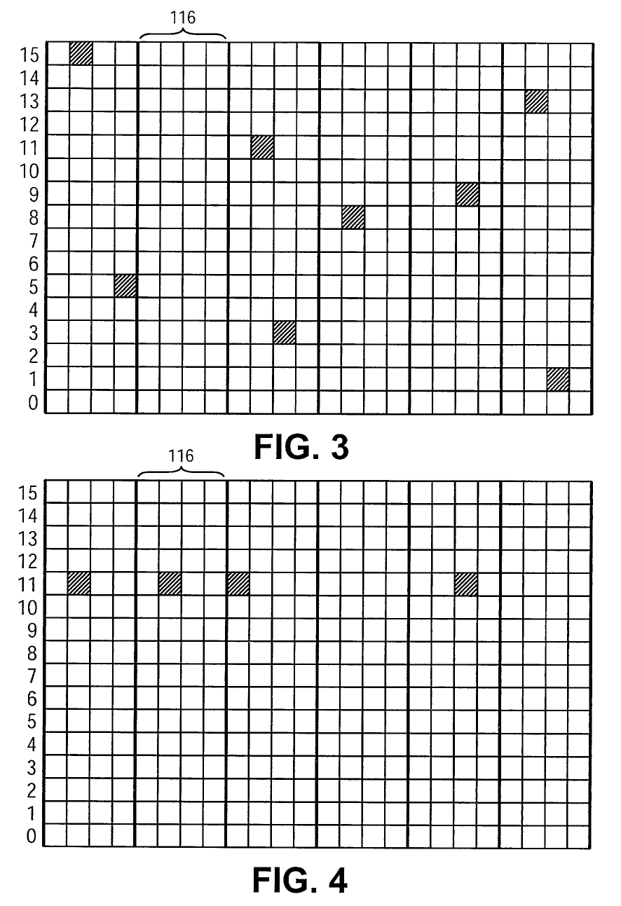

FIGS. 3 through 6 illustrate mappings of transmission errors with data lanes and data intervals according to alternative embodiments of the system shown in FIG. 1. For each bit sample interval, the data sequence analyzer 18 may recover a single bit sample. The evaluation period comprises six data block intervals 116 of four bit sample intervals for each of the sixteen data lanes. For each case illustrated in FIGS. 3 through 6, an application program may draw inferences about the operation of the underlying data link (e.g., chip to chip data link) based upon compressed data including counter values at the end of an evaluation period.

In FIG. 3, the counter values for the illustrated evaluation period may indicate that for each data lane the single bit errors are equal to the number of data block intervals 116 having one or more single bit errors. The counter values may also indicate that the total number of bit sample errors equals the number bit sample intervals for which there is at least one bit sample error. Based upon these counter values, an application program may infer that the errors are uniformly distributed temporally (across data block intervals 116) and from lane to lane, and that the cause of the errors is transmission errors on an optical fiber coupling the source device 12 to the sink device 14.

In FIG. 4, the counter values for the illustrated evaluation period may indicate that there are only errors at lane 11 and that the bit sample errors for lane 11 are equal to the number of data block intervals 116 having one or more bit sample errors. Based upon these counter values, an application program may infer that the errors are uniformly distributed in lane 11 over evaluation period, and that clock and data signals in lane 11 may be skewed (e.g., due to routing of lane 11 in a chip to chip interconnection).

In FIG. 5, the counter values for the illustrated evaluation period may indicate that there are only errors at lane 15 and that the number of bit sample errors for lane 15 (five) is disproportionately higher than the number of data block intervals 116 having one or more bit sample intervals (two). Based upon these counter values, an application program may infer the presence of a burst disturbance affecting lane 15 such as, for example, crosstalk from any other signal physically close to lane 15 in a chip to chip interconnection (e.g., on a PCB between a physical layer device and a layer 2 device).

In FIG. 6, the counter values for the illustrated evaluation period may indicate the presence of at least one single bit error on six data lanes, with only one data block interval 116 having at least one bit sample interval for all data lanes. Based upon these counter values, an application program may infer the presence of a burst disturbance anywhere in the system caused by, for example, the phase shift of the clock signal due to jitter or insufficient jitter clean up.

In the illustrated embodiment, application programs on the host processing system may analyze the detected bit transmission errors to draw inferences regarding the data lanes formed in a circuit board coupling source and sink devices. The application programs may also draw other inferences regarding system level designs including the source and sink devices coupled by a chip to chip interconnection, as well as other devices upstream of the source devices. The application programs may make these inferences based upon the incidence of bit transmission errors as indicated in the data file. For example, an application program may determine a BER for the combination of data lanes over the evaluation interval by, for example, dividing the number of transmission errors by the number of bits transmitted over the evaluation interval. Similarly, an application program may determine a BER for a particular data lane by dividing the number of transmission errors in the data lane by the number of bits transmitted in the data lane over the evaluation interval. Also, an application program may determine a BER for a particular bit position in a data lane (i.e., bit position in each bit sample interval) by dividing the number of transmission errors in the bit position by the number bits transmitted in the bit position over the evaluation interval.

As discussed above, the sink device 14 synchronously samples the data signals from each of the data lanes at bit sample intervals. The phase the bit sample intervals relative to the clock signal 20 may be altered (e.g., a controlled by the test data sequence analyzer 18). If the data signals in the data lanes are aligned, the bit error rates in the data lanes may change together in that BERs at each data lane may increase or decrease together as a function of changes in the phase of the bit sample intervals. However, if the data lanes are misaligned or skewed, BERs for respective data lanes that are skewed with respect to one another may not increase or decrease together as a function of changes in the phase of the bit sample intervals.

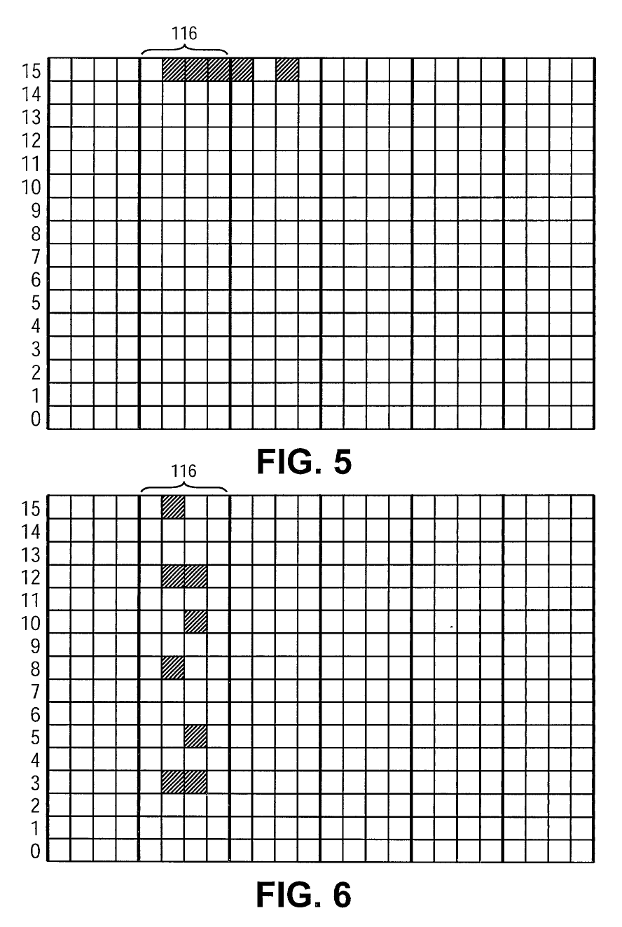

FIGS. 7 illustrates signal power 202 and 204 of data signals in substantially aligned respective data lanes sampled during synchronized bit sample intervals Δt and phase shifted bit sample intervals Δt′. Sampling the data signals at the bit sample intervals Δt may substantially optimize a signal to noise ratio for detecting data bits from each of the substantially aligned data lanes. As the phase of the bit sample intervals are shifted from Δt to Δt′, bit transmission errors may begin to occur on the data lanes as the signal to noise ratio for detecting data bits decreases. In this particular example, an increase bit transmission errors may begin to appear initially on the data lane transmitting data signal 202 as the phase of the bit sample interval is being shifted toward the peak signal strength of data signal 204.

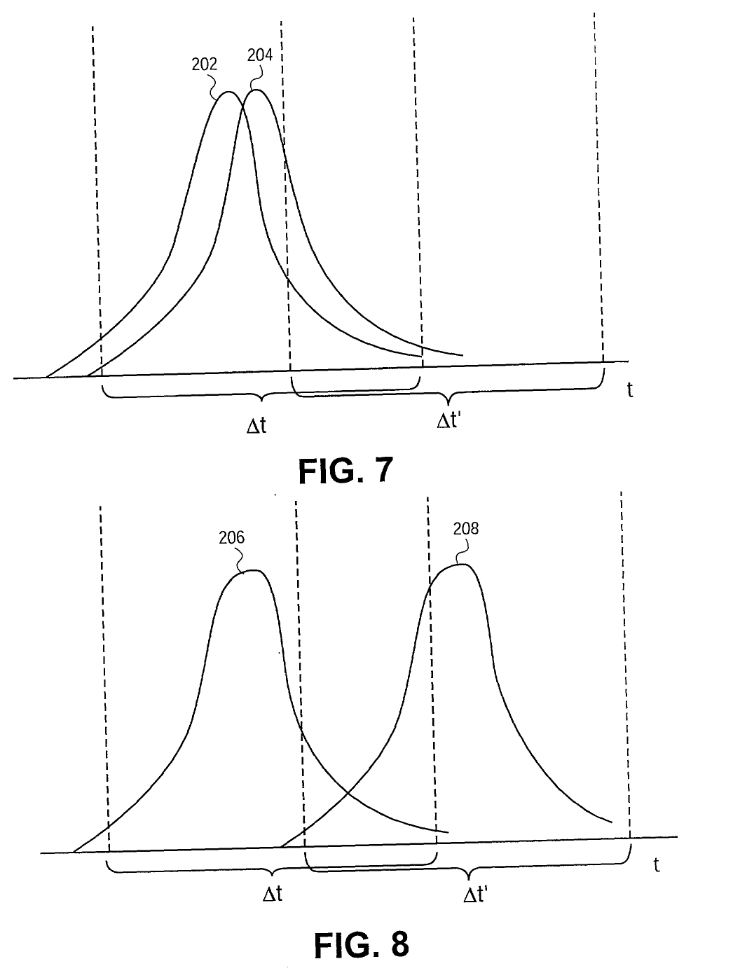

In another example, FIG. 8 illustrates signal power 206 and 208 of data signals in respective data lanes that are substantially misaligned or skewed. These data signals are shown as being sampled during bit sample intervals Δt and phase shifted bit sample intervals Δt′. Sampling the data signals at the bit sample interval Δt may substantially optimize a signal to noise ratio for detecting data bits for the data lane associated with signal power 206. However, sampling at this interval may introduce bit transmission errors for the data lane associated with signal power 208 from a lower signal to noise ratio (resulting from peak signal power being off-center within Δt). As the phase of the bit sample intervals is shifted from Δt to Δt′, bit transmission errors may begin to increase on the data lane associated with signal power 206 as the signal to noise ratio for detecting data bits decreases. Meanwhile, bit transmission errors may decrease on the data lane associated with the signal power 208 as the signal to noise ration for detecting data bits increases (since the peak of signal power 208 is more centered in Δt′ than in Δt).

In the embodiment of FIGS. 1 and 2, a test data sequence may be executed for each of multiple phases of the bit sample interval times where the phase of each bit sample intervals for a corresponding test sequence is offset from the clock signal 20 by a corresponding phase offset (e.g., from bit sample intervals Δt to phase shifted bit sample intervals Δt′ as illustrated in FIGS. 3 and 4). An application program may then analyze the data file 100 from each of the test data sequences to identify any misaligned or skewed data lanes based upon relative changes in BERs between data lanes.

While there has been illustrated and described what are presently considered to be example embodiments of the present invention, it will be understood by those skilled in the art that various other modifications may be made, and equivalents may be substituted, without departing from the true scope of the invention. Additionally, many modifications may be made to adapt a particular situation to the teachings of the present invention without departing from the central inventive concept described herein. Therefore, it is intended that the present invention not be limited to the particular embodiments disclosed, but that the invention include all embodiments falling within the scope of the appended claims.

What is claimed is:

1. A method comprising:
generating a test data sequence on each of a plurality of data lanes from a source device;
receiving the test data sequence from each data lane at a sink device;
detecting transmission errors in test data received from at least one data lane; and
at the sink device, outputting data representative of at least some detected transmission errors in association with at least one of a data interval and a data lane.

2. The method of claim 1, wherein outputting data representative of each detected transmission error comprises, at the sink device, outputting data representative of each detected transmission error in association with a bit position in a data lane.

3. The method of claim 1, wherein generating test data sequence comprises generating a pseudo random bit sequence on each data lane.

4. The method of claim 1, the method further comprising:
sampling data signals of each of the data lanes at bit sample intervals;
adjusting a phase of the bit sample intervals relative to the data signals; and
correlating transmission errors detected on data lanes with changes in the phase of the bit sample intervals to detect data skew among data signals of the data lanes.

5. The method of claim 1, the method further comprising:
receiving the data representative of each detected transmission error; and
determining a bit error rate associated with one or more of the data lanes.

6. The method of claim 1, wherein the data lines comprise circuit traces formed on a printed circuit board.

7. The method of claim 6, the method further comprising transmitting data signals in each of the data lanes according to a differential pair signaling format.

8. The method of claim 6, the method further comprising transmitting data signals in each data lane according to a single ended signaling format.

9. The method of claim 1, the method further comprising:
counting detected data transmission errors in the tested data received from the at least one data lane over an evaluation interval to generate a count; and
outputting the count to a host processing system.

10. The method of claim 1, the method further comprising:
partitioning an evaluation interval into a plurality of data block intervals, each data block intervals comprising a plurality of bit sample intervals;
for at least one data lane, counting data block intervals having at least one data transmission error to generate a count; and
outputting the count to a host processing system.

11. The method of claim 10, the method further comprising:
counting data block intervals over the evaluation interval having at least one data transmission error in any of the data lanes to generate a second count; and
outputting the second count to the host processing system.

12. The method of claim 10, the method further comprising:
for the at least one data lane, counting detected data transmission errors over the evaluation interval to generate a second count; and
outputting the second count to the host processing system.

13. A sink device comprising:
a data lane interface to receive data signals on each of a plurality of data lanes;
a transmission error detector to detect transmission errors in test data received from each data lane; and
logic to associate at least some of the detected transmission errors with at least one of a data interval and a data lane.

14. The sink device of claim 13, the sink device further comprising an output interface to output data representative of at least some of the detected transmission errors in association with at least one of a data interval and a data lane.

15. The sink device of claim 14, the sink device further comprising logic to associate each detected transmission error with a bit position in a data lane.

16. The sink device of claim 13, wherein the test data comprises a pseudo random bit sequence.

17. The sink device of claim 13, the sink device further comprising:
a plurality of sampling circuits, each sampling circuit being associated with one of the data lanes to sample a data signal on the data lane at synchronized bit sample intervals; and
logic to adjust a phase of the bit sample intervals relative to the data signal received on the data lanes.

18. The sink device of claim 13, wherein the data lane interface comprises integrated circuit pins.

19. The sink device of claim 18, wherein the data lane interface comprises circuitry to receive data signals on each of the data lanes according to a differential pair signaling format.

20. The sink device of claim 18, wherein the data lane interface comprises circuitry to receive data signals in each data lane according to a single ended signaling format.

21. The sink device of claim 13, the sink device further comprising:
a counter to count detected data transmission errors in the tested data received from the at least one data lane over an evaluation interval to generate a count; and
logic to output the count to a host processing system.

22. The sink device of claim 13, the sink device further comprising:
logic to partition an evaluation interval into a plurality of data block intervals, each data block intervals comprising a plurality of bit sample intervals;
for at least one data lane, a counter to count data block intervals having at least one data transmission error to generate a count; and
logic to output the count to a host processing system.

23. The sink device of claim 22, the sink device further comprising:
a counter to count data block intervals over the evaluation interval having at least one data transmission error in any of the data lanes to generate a second count; and
logic to output the second count to the host processing system.

24. The sink device of claim 22, the method further comprising:
for the at least one data lane, counting detected data transmission errors over the evaluation interval to generate a second count; and
outputting the second count to the host processing system.

25. A system comprising:
a source device to generate a test data sequence on each of a plurality of data lanes formed on a chip to chip; and
a sink device coupled to the source device through the chip to chip, the sink device comprising:
a data lane interface to receive data signals on each of a plurality of data lanes;
a transmission error detector to detect transmission errors in test data received from each data lane; and
logic to associate at least some of the detected transmission errors with at least one of a data interval and a data lane.

26. The system of claim 25, wherein the source device comprises forward error correction logic and the sink device comprises a SONET framer.

27. The system of claim 25, wherein the source device comprises a SONET framer and the sink device comprises one of a switch fabric and a packet processor.

28. The system of claim 25, wherein the source device comprises a deserializer.

29. The system of claim 25, wherein the source device comprises a physical layer receiver and the sink device comprises an Ethernet media access controller.

30. The system of claim 25, wherein the source device comprises a physical layer transceiver and the sink device comprises forward error correction logic.

31. The system of claim 25, wherein the source and sink devices each comprise an extender sublayer device coupled to an attachment unit interface.
